(19) United States
(12) Patent Application Publication
(10) Pub. No.: US 2007/0267141 A1
(43) Pub. Date: Nov. 22, 2007

(54) Primerless Adhesion of Profiled Sections

(75) Inventors: Elke Ehrmann, Karlsruhe (DE); Klaus Becker-Weimann, Karlsruhe (DE)

Correspondence Address: BIRCH STEWART KOLASCH & BIRCH, PO BOX 747, FALLS CHURCH, VA, 22040-0747, US

(73) Assignee: Klebchemie M.G. Becker GmbH + Co. KG, Weingarten/Baden (DE)

(21) Appl. No.: 11/792,059

(22) PCT Filed: Dec. 1, 2005
(86) PCT No.: PCT/EP05/12817

§ 371 Date: Aug. 8, 2007

(30) Foreign Application Priority Data
Dec. 1, 2004 (DE) 10 2004 057 988.1

(51) Int. Cl. B32B 37/12

(52) U.S. Cl. 156/321; 156/331.7; 156/322

(57) ABSTRACT

The present invention relates to a process for the mechanical foil bonding of profiled workpieces.

The present invention relates to a process for the mechanical foil bonding of profiled workpieces.

The adhesive bonding of articles, particularly in the industrial sector, is an operation which must be carried out precisely in order to obtain adequate bonding results. For a good bonding result it must be ensured that bonding takes place uniformly and durably. In the general case of many applications, such as with the bonding of plastics to one another, as in the case of window profiles to which protective and/or decorative foils are to be adhered, it is common first to pretreat the substrate in order to achieve good bonding results.

In the prior art there are a variety of pretreatment steps known.

Commonly a material (primer) is applied which ensures that the adhesive for subsequent application forms an intimate join with the plastic support of the base body. The primer therefore serves to promote adhesion by acting on the surface of the article to be bonded.

Typically in this case a primer layer of about 1-30 μm is applied. This can be accomplished, for example, by moving the article on a conveyor track along an applicator device such as a felt pad.

The primer frequently comprises a polyester resin in solution in volatile, organic solvents such as dichloromethane. The use of primers based on volatile organic solvents, however, is increasingly undesirable, for a variety of reasons. For example, the removal of the gaseous solvent present in the air is costly.

Water-based primers, of the kind disclosed in, for example, DE-A 44 28 382, avoid the problems described above, but frequently have the disadvantage that, in conventional plants, between application of the primer and adhesive bonding, the exposure time is too low and/or it is necessary to apply such a quantity of material that, in view of the low vapour pressures, it is impossible for the primer to dry sufficiently.

Consequently pretreatment steps have also been developed that allow the use of primers to be avoided.

German application No. 103 20 581.0, for instance, describes the use of brushes for the mechanical preparation of the surface to be bonded.

Furthermore, German Patent Application No. 10 2004 034 795.6 proposes that the use of primers can be avoided when one of the articles to be bonded is pretreated by means of dry ice.

Also known is pretreatment with soap solution.

In all of these processes, however, a condition is that for the bonding, for example, of a foil to a profiled workpiece, a preparation step is necessary before an adhesive is applied to at least one surface. Furthermore, for practical reasons, it is assumed that, when a foil is bonded to a profiled workpiece, the adhesive ought first to be applied to the foil.

It is an object of the present invention to provide a process which foregoes the aforementioned pretreatment steps and is therefore easier to carry out while nevertheless being able to provide comparably good bonding results.

The object is achieved by means of a process for the mechanical foil bonding of profiled workpieces, comprising the steps of
(a) applying an adhesive to the region of the workpiece surface that is to be bonded;
(b) applying the foil to the region of the workpiece surface that is to be bonded,
   characterized in that none of the following steps for preparing the workpiece surface is carried out before the adhesive is applied:
pretreatment by soap solution;
mechanical pretreatment by means of brushes;
pretreatment with dry ice; or
pretreatment with primers.

It has in fact been found that, contrary to the opinion in the prior art, sufficient adhesive bonding can be achieved if the known pretreatment steps are foregone but the adhesive is applied to the profiled workpiece instead of to the foil that is to be bonded.

It has additionally been found that the adhesive effect can be increased further if the profiled workpiece and/or the adhesive have been heated when the adhesive is applied.

The adhesive bonding is preferably not preceded by any preparation step by brushes, jets, primers or treatment with soap solution. With particular preference the adhesive bonding step is not preceded by any mechanical and/or chemical pretreatment.

It is preferred for both the application of the adhesive and the application of the foil to take place mechanically. It is, however, also possible for only one of these steps to be carried out mechanically.

For the application of the adhesive there are a number of possibilities. The application could be used by means of an application tool in the form of a workpiece impression over which the adhesive is applied.

A further possibility would be the two-dimensional application of the adhesive to the top profile face of the workpiece in a slight excess, with the possibility of subsequent spreading or diverting of the excess onto the adjacent profile faces by means of a doctor blade or spatula.

Likewise possible would be the application of the adhesive by means of flexibly adjustable roller systems. These systems are also suitable for the application of the foil following the adhesive application.

The foil is applied to the area that is to be bonded by means in particular of profile wrapping devices. Such devices are, for example, from the companies Friz Kaschiertechnik GmbH (Weinsberg, DE), Barberán (Barcelona, ES) and Delle Vedove Levigatrici SpA (Pordenone, IT).

The workpiece is preferably an elongated profiled article, in particular a window profile. Normally the profiled workpiece is composed of plastic. The process of the invention can also be applied, however, to aluminium or alloys thereof, of the kind used, for example, in window construction.

The plastic is here composed typically of thermoplastics, such as, for example, polyethylene, polypropylene, polybutylene, polyvinyl chloride (PVC), polyacrylates or polymethacrylates, or mixtures thereof. With preference the plastic article is composed of PVC or polypropylene.

It is advantageous if the workpiece and/or the adhesive have been heated when the adhesive is applied to the workpiece surface. The temperature is preferably at least 40° C.

Further suitable temperatures for the adhesive and/or the workpiece are at least 50° C., preferably at least 60° C., more preferably at least 80°C. The upper limit of the adhesive is formed here solely by the boiling/melting point/range of the adhesive. A further upper limit to be taken into account is the temperature stability of the workpiece.

The workpiece in particular may have higher temperatures, above 100° C. for example. Even temperatures of at least 125° C., preferably at least 150° C., are possible, provided that they are not in contradiction with the dimensional stability of the workpiece.

If workpiece and adhesive are heated, the two may have the same or different temperatures. For the purposes of the present invention it is enough for only the region of the surface that is to be bonded, in particular the outermost boundary layer of the surface, to have the specified temperature, despite the use, for the purpose of simplification, only of the term “material” in this context.

For the purposes of the present invention, adhesive or the region of the material surface that is to be bonded is considered to be heated when its temperature differs by more than 10° C., preferably by more than 15° C., from the ambient temperature. The starting point for the ambient temperature is preferably 20°C. Therefore, for the purposes of the present invention, a heated state is considered to exist when, with a typical room temperature of approximately 20° C., the adhesive or the surface of the material has a temperature of greater than 30° C., preferably greater than 35° C.

As already mentioned, sufficient adhesive bonding can be achieved if the profiled workpiece is provided with adhesive. This makes it no longer absolutely necessary for adhesive to be applied to the foil in addition. Nevertheless, this may additionally take place.

The adhesive used may be a solvent-borne adhesive (based on polyester, for example), but is preferably solvent-free.

The adhesive is preferably applied in a thickness of 10 to 150 μm by known methods.

The adhesive in question is preferably a polyurethane (PUR)-based adhesive, more particularly reactive PUR hot melt adhesives of the kind sold for example by the applicant as Kleiberit® PUR SK series.

The process of the invention is particularly suitable if the region to be bonded comprises the entire workpiece surface (foiling).

The two-dimensional adhesive bonding may also take place with preference in the form of partial wrapping.

The foil thickness is preferably about 20 μm to 400 μm. The foil surface to be bonded is composed preferably of PVC, polyacrylate or polyester or of a wood veneer.

The strength of adhesion of the foils bonded by the process of the invention is sufficient. The strength of adhesion can be determined with the aid of what is called the peel value. This a measure of the force needed to peel the foil from the workpiece. In this context, a peel value of at least 2.5 N/mm in accordance with RAL 716-1 Part 7 ought to be achieved. Preferably a value of 3.0 N/mm after 1 week is achieved in accordance with the RAL indicated above.

The present invention is elucidated in more detail with reference to the following example.

### EXAMPLE

A polyurethane adhesive (Kleiberit PUR 704.5) was applied to the surface of an unpretreated PVC window profile and the surface was wrapped with a PVC foil. The test was carried out for different surface temperatures of the profile. After 7 days the peel value was determined in accordance with RAL 716-1 Part 7.

The minimum value of 2.5 N/mm specified in the RAL was attained without any need for pretreatment by brushes or jets (for example, with the aid of dry ice) or with the aid of primers or soap solution, for example. The adhesive bonding step was not preceded by any mechanical or chemical pretreatment, therefore.

Moreover, it was found that the adhesive bonding of heated profiles gave better peel values.

1-10. (canceled)

11. Process for the mechanical foil bonding of profiled workpieces, comprising the steps of
(a) applying an adhesive to the region of the workpiece surface that is to be bonded;
(b) applying the foil to the region of the workpiece surface that is to be bonded,
where none of the following steps for preparing the workpiece surface is carried out before the adhesive is applied:
pretreatment by soap solution;
mechanical pretreatment by means of brushes;
pretreatment with dry ice; or
pretreatment with primers,
characterized in that the adhesive is a polyurethane adhesive.

12. Process according to claim 11, characterized in that the application of the foil is carried out mechanically with the aid of a profile wrapping device.

13. Process according to claim 11, characterized in that the workpiece is an elongated profiled article, preferably a window profile.

14. Process according to claim 11, characterized in that the workpiece has been heated when the adhesive is applied to the workpiece surface.

15. Process according to claim 11, characterized in that the adhesive has been heated when the adhesive is applied to the workpiece surface.

16. Process according to claim 14, characterized in that the temperature is at least 40° C.

17. Process according to claim 11, characterized in that the region to be bonded comprises the entire workpiece surface.

18. Process according to claim 11, characterized in that the foil surface to be bonded is composed of PVC, polyacrylate or polyester or of a wood veneer.

19. Process according to claim 11, characterized in that the peel value of the applied foil is at least 2.5 N/mm in accordance with RAL 716-1 Part 7.

20. Process according to claim 15, characterized in that the temperature is at least 40° C.
